(19) United States
(12) Patent Application Publication
(10) Pub. No.: US 2018/0359315 A1
(43) Pub. Date: Dec. 13, 2018

(54) SYSTEMS AND METHODS FOR PROVIDING INTER-DEVICE CONNECTIVITY AND INTERACTIVITY

(71) Applicant: LENOVO (SINGAPORE) PTE. LTD., New Tech Park (SG)

(72) Inventors: Adiyan Mujibiya, New Tech Park (SG); Jun Luo, New Tech Park (SG)

(73) Assignee: LENOVO (SINGAPORE) PTE. LTD., New Tech Park (SG)

(21) Appl. No.: 15/620,591

(22) Filed: Jun. 12, 2017

(51) Int. Cl. H04L 29/08; H04L 29/06

(52) U.S. Cl. CPC H04L 67/1095; G06F 3/04883; H04L 63/102; H04L 65/4015

(57) ABSTRACT

Systems and methods for providing inter-device connectivity and interactivity are described. In some embodiments, the systems can include a user device and a display unit connected over a network for sharing event data. The user device and the display unit can include sensors thereon for detecting a gesture than can be associated with events that generate commands to perform tasks. Event data collected from the sensors can be compared and normalized to determine if the event is synchronized between the user device and the display unit such that the event data collected by the user device corresponds to the event data collected by the display unit. If the event is synchronized, the system can perform the tasks. Lack of synchronization can suggest that the user device is non-authorized and the display unit can activate a non-authorized mode of use. In some embodiments, a cloud infrastructure can be used to compare and normalize event data.

### FIELD OF INVENTION

The present disclosure generally relates to devices and methods for establishing inter-device connectivity and interactivity.

### BACKGROUND

The sheer volume of advancements in modern technologies have created an abundance of information that needs to be stored and disseminated efficiently. For example, user devices, e.g., personal computers, laptop computers, tablets, smart phones, etc., have become widely available for professional as well as at-home use. While the prevalence of these devices has greatly simplified the way in which the public receives and processes information, the wide availability of these devices has led to inefficient data sharing and the presence of duplicative information. Many users have devices that are made by different manufacturers, which may run different operating systems and may support file extensions that are incompatible across multiple brands. As a result, rather than having uniform content across all of their devices, users often use their devices in isolation, having duplicative versions of the same file stored on multiple devices.

Further, increased device use has increased the existence of private and sensitive data on user devices, which has led to ramped up efforts to protect the public from identity theft, cyber-attacks, and data theft. Typical user devices thus have to strike a delicate balance between data availability and data security to ensure that information contained therein is both accessible and secure.

Although advances have been made in content collaboration and distribution, existing devices and methods for disseminating information to the public have numerous shortcomings. Collaboration platforms can allow multiple users access to a document, but may fail to notify these users that cotemporal edits are being made, thereby resulting in creation of multiple versions of the document. These platforms can also have delayed synchronization methods that prevent revisions of files from occurring in real-time. Further, setting of content editing permissions can be complex or non-existent, which can restrict users' access to generally available documents while undesirably granting the public access to private documents.

Accordingly, there is a continual need for systems and methods that regulate user identification and provide inter-device connectivity and interactivity.

### SUMMARY OF THE INVENTION

In some embodiments, a method can include detecting occurrence of an event using a user device, the user device being configured to collect a first event data in a temporal instance; detecting occurrence of the event using a display unit, the display unit being configured to collect a second event data in the temporal instance; determining if the user device is authorized to perform a first task associated with the event by analyzing whether the first event data is synchronized with the second event data; and performing the task that is associated with the event, if the user device is authorized.

The first event data can be one or more parameters selected from the group consisting of an event type, a timestamp, a location of the event relative to the display unit, and a pattern received by one or more device sensors; and the second event data can be one or more parameters selected from the group consisting of an event type, a timestamp, a location of the event relative to the display unit, and a pattern received by one or more display sensors. The parameters of the first event data can be collected in the temporal instance. The parameters of the second event data can be collected in the temporal instance. The event can be detected using one of a motion sensor, an optical-visual sensor, an audio sensor, or a touch sensor.

In one aspect, determining authorization of the user device can be performed on a cloud infrastructure. In another aspect, determining authorization of the user device can be performed on the display unit. The user device can include a user memory that stores the task that is associated with the event; and the display unit can include a display memory that stores the task that is associated with the event.

In some embodiments, the method can include performing a second task that is associated with the event, if the user device is authorized, the second task being different from the first task. A second user device can include a second user memory that stores a second task that is associated with the event; and the display unit can include a display memory that stores the second task that is associated with the event. The first task and the second task can be performed within a same display output of the display unit. The first task can include annotating the display unit by modifying content thereon. The display unit can include a user area, the user area defining a space within which content can be modified. The content in the user area cannot be modified by a second user device, the second user device being non-authorized to modify content in the user area.

The method can include adding a tag to the annotated content. The tag can include user identification information and timestamp of modification. The event can include a synchronization event that can be configured to relay information from the user device to the display unit to perform the task.

In some embodiments, a control system can include one or more user devices configured to perform one or more gestures, the user devices having a device processor that analyzes the gestures to gather a first event data therefrom; a display unit configured to detect occurrence of one or more gestures relative thereto, the display unit having a display processor that analyzes the gestures to gather a second event data therefrom; a network that connects the one or more user devices and the display unit, the network being configured to share the first event data and the second event data across the system; and a computing module that receives the first event data and the second event data, the computing module being configured to perform computations to determine the existence of synchronization between the first event data and the second event data.

The computations can be performed by a cloud infrastructure connected to the network, the cloud infrastructure being configured to receive the first event data and the second event data therefrom. The computing module can generate a command to perform a task if the first event data is synchronized with the second event data. The control system can include an output configured to perform the task and to receive the command to perform the task, the output being positioned on the display unit.

### BRIEF DESCRIPTION OF THE DRAWINGS

The invention will be more fully understood from the following detailed description taken in conjunction with the accompanying drawings, in which:

FIG. 1A is a block diagram of an embodiment of a system that can be used to synchronize information between system modules.

FIG. 1B is a block diagram of another embodiment of a system that can be used to synchronize information between system modules.

FIG. 2A is a schematic view of an example user device of the system of FIGS. 1A-1B.

FIG. 2B is a perspective view of another example user device of the system of FIGS. 1A-1B.

FIG. 2C is a schematic view of another example user device of the system of FIGS. 1A-1B.

FIG. 3 is a block diagram of the architecture of the user device of FIG. 2.

FIG. 4 is a block diagram of the architecture of a display unit of the system of FIGS. 1A-1B.

FIG. 5 is a block diagram of the architecture of a cloud infrastructure of the system of FIG. 1B.

FIG. 6A is a pictorial representation of an embodiment of the system in which a user interacts with the display unit.

FIG. 6B is a pictorial representation of the system of FIG. 6A in which multiple users interact with the display unit.

FIG. 7 is a simplified flow diagram of the procedures that may be used by embodiments described herein for a system in which data computation is performed on the cloud infrastructure.

FIG. 8 is a simplified flow diagram of the procedures used by the software modules and hardware components of the user device and display unit for synchronization with system modules.

FIG. 9 is a simplified flow diagram of the procedures used by the software modules and hardware components of the cloud infrastructure for synchronization with system modules.

FIG. 10 is a simplified flow diagram of the procedures that may be used by embodiments described herein for a system in which data computation is performed on the display unit.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

In the present disclosure, like-named components of the embodiments generally have similar features, and thus within a particular embodiment, each feature of each like-named component is not necessarily fully elaborated upon. Sizes and shapes of devices and components of electronic devices discussed herein can depend at least on the electronic devices in which the devices and components will be used and the invention described herein is not limited to any specific size or dimensions.

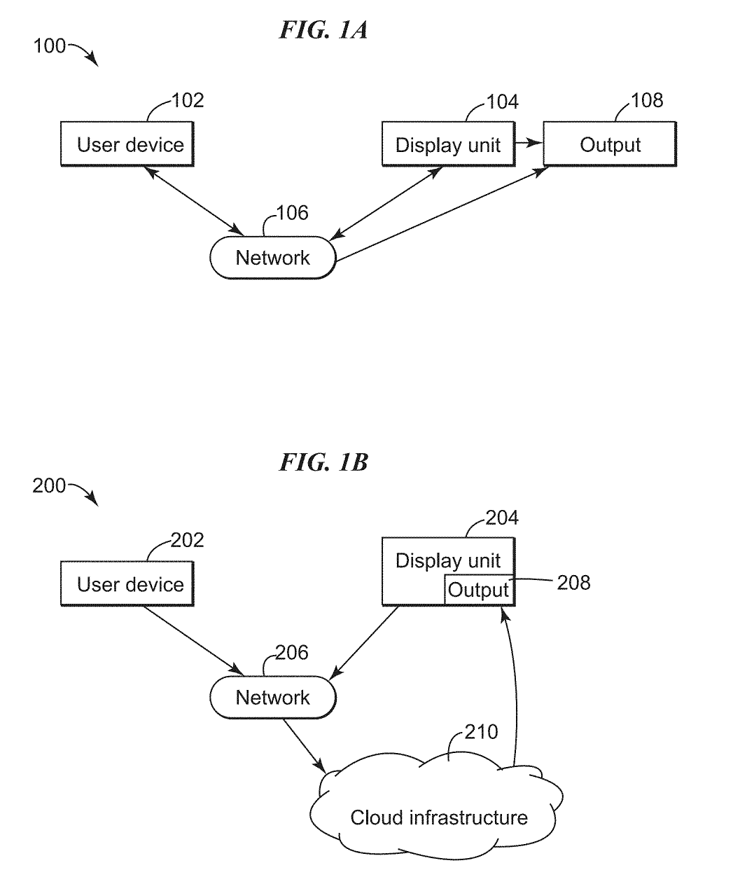

A person skilled in the art will recognize a variety of different computer-based technologies that can be used to carry out disclosures contained herein. For example, the devices, systems and methods disclosed herein can be implemented using one or more computer systems, such as the exemplary embodiments of the computer systems 100, 200 shown in FIGS. 1A-1B.

FIG. 1A is a block diagram of an example system 100 that can use one or more modules to provide inter-device connectivity and interactivity. The system modules can include a user device 102, a display unit 104, and a network 106 for communicating therebetween. The user device 102 can be configured to connect with the display unit 104 via the network 106 to share content and synchronize the system modules. For example, the system can activate in response to an event performed by the user device 102 to initiate interactivity between system modules, e.g., content modification, synchronization, and so forth, throughout the system. The event can be initiated by performing a gesture with the user device 102, as described further below.

In the illustrated embodiment, the user device 102 and the display unit 104 can each send event data to one another, and to other system modules, over the network 106. The display unit 104 can include one or more computational parts therein, e.g., CPU, memory part, and one or more network I/O interface(s), to function as a content server that can perform event data computations. The network I/O interface(s) can include one or more interface components to connect systems with other electronic equipment. For example, the network I/O interface(s) can include high speed data ports, such as USB ports, 1394 ports, etc. Additionally, systems can be accessible to a human user, and thus the network I/O interface(s) can include displays, speakers, keyboards, pointing devices, and/or various other video, audio, or alphanumeric interfaces.

In some embodiments, systems can include one or more storage device(s). The storage device(s) can include any conventional medium for storing data in a non-volatile and/or non-transient manner. The storage device(s) can thus hold data and/or instructions in a persistent state (i.e., the value is retained despite interruption of power to the systems). The storage device(s) can include one or more hard disk drives, flash drives, USB drives, optical drives, various media cards, and/or any combination thereof and can be directly connected to any module in the systems or remotely connected thereto, such as over a network. The various elements of the systems can also be coupled to a bus system (not shown). The bus system is an abstraction that represents any one or more separate physical busses, communication lines/interfaces, and/or multi-drop or point-to-point connections, connected by appropriate bridges, adapters, and/or controllers.

As shown in FIG. 1A, event data from the user device 102 and the display unit 104 can be returned to the display unit 104 for computation and output. The display unit 104 can analyze the event data and perform a task associated therewith. Some non-limiting examples of tasks that can be performed by the system may include performing a data synchronization between the user device 102 and the display unit 104, modifying content of a file, adding metadata to a user interaction, and so forth. Additional examples of tasks are described in further detail below. In some embodiments, the task can be performed by sending a command to an output 108 of the display unit 104, as described further below.

In an alternative embodiment, as shown in FIG. 1B, a system 200, which is substantially similar to the system 100 described above can be configured to perform computations on a cloud infrastructure or content server 210. The system 200 can include a user device 202, a display unit 204, and a network 206. Event data from the user device 202 and the display unit 204 can travel across the network 206 to the cloud infrastructure 210. The cloud infrastructure 210 can compute the event data between the user device 202 and the display unit 204, or across multiple devices, to analyze whether the event data is synchronized. In the illustrated embodiment, after the event data is analyzed, the cloud infrastructure 210 can send a command to an output 208 of the display unit 204 to perform the task associated with the command. It will be appreciated that the system described herein can share event data across other modules, or other systems, to compute and analyze event data. In some embodiments, the cloud infrastructure 210 can perform computations on event data received from three or more modules. The system can also include various computer executable instructions for collaboration in content editing and personalized annotation.

Although exemplary computer systems are depicted and described herein, it will be appreciated that this is for sake of generality and convenience. In other embodiments, the systems may differ in architecture and operation from that shown and described here. The elements illustrated in FIGS. 1A-1B can be some or all of the elements of a single physical machine. In addition, not all of the illustrated elements need to be located on or in the same physical or logical machine.

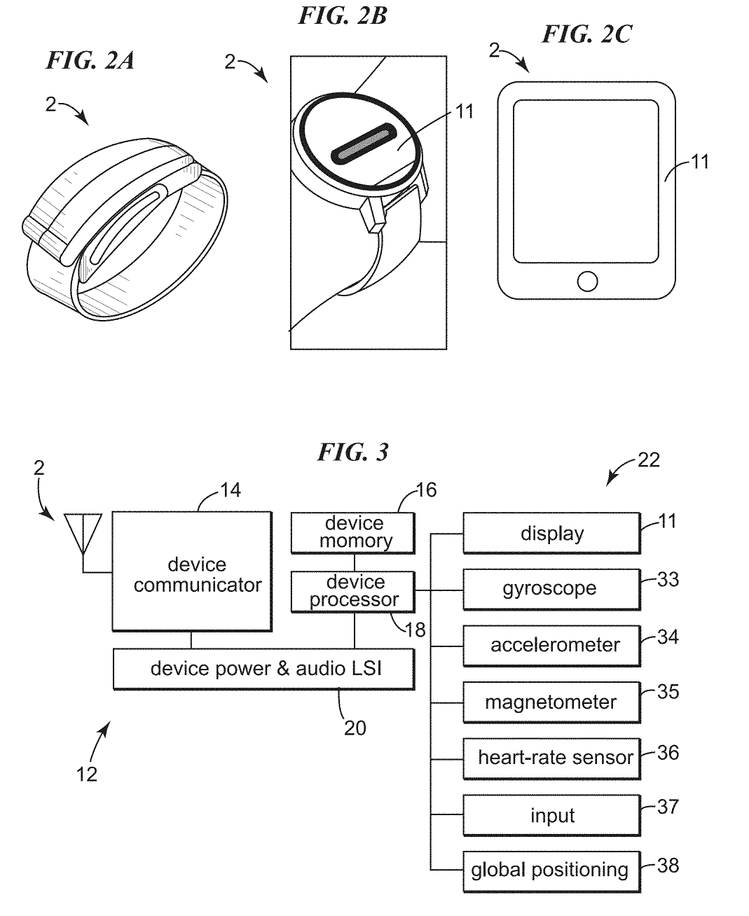

FIGS. 2A-2C illustrates exemplary embodiments of a user device 2. As shown in FIGS. 2A-2B, the user device 2 can be wearable, e.g., a watch, ring, band, and so forth, though it will be appreciated that the user device can be handheld, as shown in FIG. 2C, e.g., a telephone, smartphone, tablet, and so forth, or a laptop, desktop computer, and the like. The user device 2 can be activated using one or more gestures that are executed using predefined patterns, such as motion, touch, and/or signals, to initiate interaction with other system modules. Gestures can be performed via body movements and tapping motions, in the case of a wearable device, or via swiping on a touchscreen and/or activating a program, in the case of handheld or other devices. Some gestures can be associated with actions or events that can send commands to system modules, e.g., the display unit, to perform tasks. The command can identify the user device, define user privileges, and/or acquire the task associated with the event, e.g., copy, delete, save, and/or move a file on the display unit. The event that is associated with a particular gesture can be preset by the user or defined by the system. In some embodiments, as shown in FIG. 2B, the user device 2 can include a display 11 for receiving and/or displaying information. The display can be a touch display, digital display, and/or any type of display known in the art.

FIG. 3 is a block diagram of an example user device 2 that can be used with the systems 100, 200 disclosed herein. The user device 2 can include device components 12 such as a device communicator 14, a device memory 16, a device processor 18, and a device power and audio LSI interface 20. The user device 2 can be configured to interact with a display unit 4 and/or other system modules in response to events detected by the user device 2. Some non-limiting examples of events can include gestures such as motion, taps, and/or swipes of the user device 2 that the systems 100, 200 can associate with the task. Gestures that are not recognized by the user device and/or the systems 100, 200 do not trigger performance of the task. Events can be detected via one or more device sensors 22, such as a motion sensor, optical-visual sensor, touch sensor, and the like, of the user device 2. It will be appreciated that the device sensors 22 can be located within the user device, on the surface of the user device, or within signal range of the user device such that the device sensors 22 can detect manipulation of the user device 2.

The device communicator 14 can connect to other system modules to send data throughout the systems 100, 200. The device communicator 14 can be configured to send and receive files and/or event data between the user device 2 and other modules of the system, such as the display unit 4, the network 6, the cloud infrastructure 10 or another user device. The device communicator 14 can send signals and information via wireless LAN, Bluetooth, cellular network, Ethernet, Wi-Fi, NFC, RFID, QR code, URL user ID input, and the like. The device communicator 14 can be configured to send and receive information simultaneously to and from one or more sources, or in response to a signal from the sources. The device communicator 14 can also communicate between multiple systems to send and receive information across multiple systems. In some embodiments, the device communicator 14 can include a sending executor 24 for sending data to system modules. The sending executor 24 can be configured to receive event data and send the data to a transfer mediator 26 to be sent to other system modules. The transfer mediator 26 can send data to system modules via Bluetooth, LAN, the internet, or another form of digital communication known to one skilled in the art.

The user device 2 can include a device memory 16. The device memory 16 can provide temporary storage for code to be executed by the device processor 18 or for data acquired from one or more users, storage devices, and/or databases. The device memory 16 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

In some embodiments, the device memory 16 can include a gesture repository (not shown) therein. The gesture repository can include one or more gesture definitions, each of which can be associated with an event. Each event, after computation by the display unit or the cloud infrastructure 10, can generate a command that signals one or more system modules to perform a specific task. Examples of gestures and their associated events can include a “single tap” gesture that sends a command to the display unit to download a file, a “double tap” gesture that sends a command the display unit to copy a file, and a swiping gesture that sends a command to the display unit to paste a file. One having ordinary skill in the art will appreciate that the gestures and events listed above are intended to be non-limiting examples of the possible gestures and events that can be defined in the gesture repository. The gesture repository can store up to 10 gestures, up to 25 gestures, up to 50 gestures, up to 100 gestures, up to 150 gestures, up to 200 gestures, up to 250 gestures, and so forth, as well as associated event definitions.

One having ordinary skill in the art will appreciate that users can customize the gesture repository. Users can create new gestures, assign specific tasks to new or created gestures, delete gestures, or edit and/or switch the existing gesture definitions in the gesture repository. In the case of multiple user devices in a system, each user device can be customized to include a different set of gestures that is associated therewith. Alternatively, each user device can associate a different event with each gesture, which can be interpreted by the systems 100, 200 to perform different tasks. For example, one user device can include settings that associate a “single tap” gesture with a synchronization event that generates a command to synchronize the display unit 4 with the user device, while a second user device can include settings that associate the “single tap” gesture with a “delete” event that generates a command to delete a selected file from the display unit 4.

The device memory 16 can be connected to the device processor 18 to send instructions and event data thereto. The device processor 18 can be configured to detect events and communicate event data via the device communicator 14 to other system modules. The device processor 18 can be a programmable general-purpose or special-purpose microprocessor and/or any one of a variety of proprietary or commercially available single or multi-processor systems. The device processor 18 can include a central processing unit (CPU, not shown) that includes processing circuitry configured to process user device data and execute various instructions. It will be appreciated that the device processor 18 can continuously scan the user device 2 for events to ensure prompt receipt and assignment of temporal event signatures to each event. In some embodiments, the device processor 18 can passively receive a signal from the user device 2 when a gesture is initiated. In some embodiments, the device processor 18 can include a command buffer 28 for receiving event data and/or commands from the display unit 4 and/or cloud infrastructure 10. The command buffer 28 can initiate performance of tasks as instructed by the command. The command buffer 28 can process the command received from system modules, e.g., cloud infrastructure 10, and initiate the interaction based on the command instructions.

For example, after the user device 2 performs a gesture relative to the display unit 4, e.g., the display unit 4 detects a swipe, touch, tap, and so forth performed by the user device 2, the device processor 18 can determine whether the gesture is associated with an event. The device processor 18 can include various features for locating and transmitting data. In some embodiments, the device processor 18 can include an event detector 30 configured to determine whether the gesture can be associated with an event. The event detector 30 can compare the signal received from one or more device sensors 22 with gesture definitions in the gesture repository to determine if the gesture is associated with an event. The event detector 30 can also parse the gesture for event data such as event type, location, and/or timestamp, among others.

If the gesture is not known in the gesture repository, the device processor 18 does not communicate the event data to the rest of the system. If the gesture is associated with an event in the gesture repository, the device processor 18 can send the event data to the device communicator 14. In some embodiments, the device processor 18 can include a report regulator 32 for creating reports based on the event data. The report regulator 32 can compile the event data into one or more reports that can be sent to other system modules. The reports can include the event data gathered by the event detector 30 such as event type, location, and timestamp, among others. The report regulator 32 can connect to the device communicator 14 to send data to other system modules.

The device processor 18 and device communicator 14 can be connected to the device power and audio LSI 20, such as a power supply and internal sound card that can be used in receiving (input) and forwarding (output) audio signals to and/or from system modules. The device power and audio LSI 20 can provide affirmative interaction feedback, e.g., a sound effect, alert, and/or notification, once an event is detected by the system 100, 200.

The user device 2 can include one or more sensors thereon that can detect gestures of the user device 2. The sensors of the user device 2, as shown in FIG. 3, can include device sensors 22 that can be connected to the event detector 30 of the device processor 18 to relay gesture information thereto. The device sensors 22 of the user device can interpret motions such as the rotation and/or bending of the arm and wrist, finger tapping gestures, and other changes of relative position of the user device to orient the position of the user device relative to system modules.

The device sensors 22 can be configured to analyze whether the gesture made by the user device 2 is associated with an event. In an exemplary embodiment, the device sensors 22 can include a gyroscope 33, accelerometer 34, and magnetometer 35 to determine the occurrence of motion events and acquire event data. One having ordinary skill in the art will appreciate the manner in which the gyroscope 33, accelerometer 34, and magnetometer 35 function in combination in order to acquire temporal and spatial event data, though, in some embodiments, the user device 2 can include one or two of these devices. A number of other device sensors 22 that can detect motion or spatial orientation can be used in conjunction with, or instead of, the gyroscope, accelerometer, and magnetometer, e.g., IR sensors, GPS sensors 38, among others, as appreciated by those skilled in the art.

The user device 2 can include a number of additional device sensors for taking measurements. For example, the user device 2 can include a heart-rate sensor 36 to measure the wearer's vitals such as heart rate, blood pressure, and/or blood oxygen content. In some embodiments, the user device 2 can include an input 37 for performing gestures. The input screen can be a touchscreen or any other display known in the art. It will be appreciated that a user device of the system can include all, some, or none of the sensors mentioned above at a given time.

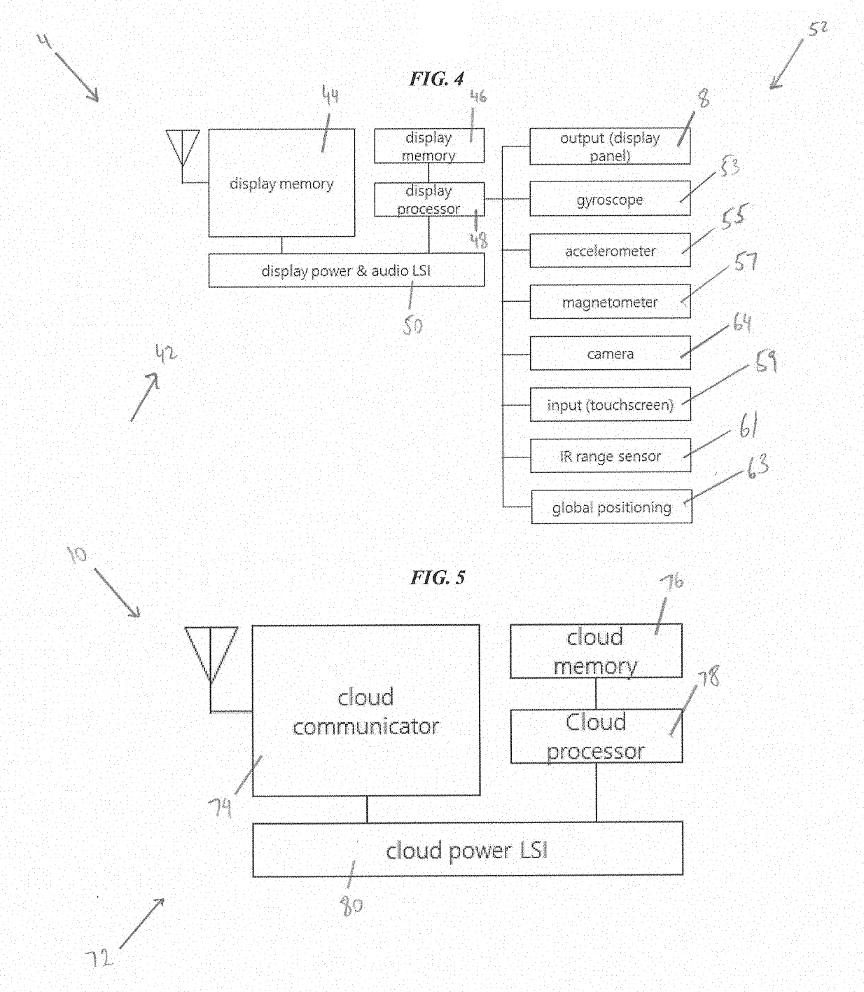

FIG. 4 is a block diagram of an example display unit 4 that can be used with the systems 100, 200 disclosed herein. The display unit 4 can be a shared computing canvas, e.g., digital whiteboard, electronic signage, presentation screen, shareboard, and so forth, or any digital media for conveying information, e.g., television, computer, projector, and so forth. The display unit 4 can be activated using one or more gestures that are executed using predefined patterns, such as motion, touch, and/or signals, of one or more user devices. The display unit 4 can include display components 42 such as a display communicator 44, a display memory 46, a display processor 48, and a display power and audio LSI interface 50. It will be appreciated that one or more of the display components 42 can function in the same way as their corresponding device components 12 in the user device 2, though one or more of the display components 42 can perform a different function. The display unit 4 can be configured to detect events and perform tasks in response to commands generated by the events. Some non-limiting examples of events can include gestures such as taps, swipes, and/or prolonged holds of portions on the display unit 4 that the systems 100, 200 can associate with the task. Gestures that are not recognized by the display unit 4 and/or the systems 100, 200 do not trigger performance of a task. Event detection can be implemented in response to one or more display sensors 52, such as a motion sensor, optical-visual sensor, touch sensor, and the like, of the display unit 4. It will be appreciated that the display sensors 52 can be located in the display unit, on the surface of the display unit, or within optical range of the display unit such that the display sensors 52 can detect manipulation of the user device 2 relative to the display unit 4. In some embodiments, the display unit 4 can normalize data received from the user device 2 by comparing and synchronizing display unit data with the user device data.

The display communicator 44 can connect to other system modules to send data throughout the systems 100, 200. The display communicator 44 can be configured to send and receive files and/or event data between the display unit 4 and other modules of the system, such as the user device 2, the network 6, cloud infrastructure 10 or another display unit. The display communicator 44 can send signals and information via wireless LAN, Bluetooth, cellular network, Ethernet, Wi-Fi, NFC, RFID, QR code, URL user ID input, and the like. The display communicator 44 can be configured to send and receive information simultaneously to and from one or more sources, or in response to a signal from the sources. The display communicator 44 can also communicate between multiple systems to send and receive information across multiple systems. In some embodiments, the display communicator 44 can include a sending executor 54 for sending data to system modules. The sending executor 54 can be configured to receive event data and send the data to a transfer mediator 56 to be sent to other system modules. The transfer mediator 56 can send data to system modules via Bluetooth, LAN, the internet, or another form of digital communication known to one skilled in the art.

The display unit 4 can include a display memory 46. The display memory 46 can provide temporary storage for code to be executed by the display processor 48 or for data acquired from one or more users, storage devices, and/or databases. The display memory 46 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

In some embodiments, the display memory 46 can include a gesture repository (not shown) therein. The gesture repository can include one or more gesture definitions that correlate to events. Each event can generate a command that signals one or more system modules to perform a specific task. Examples of gestures and their associated events can include a “single tap” gesture that sends a command to the display unit to download a file, a “double tap” gesture that sends a command the display unit to copy a file, and a swiping gesture that sends a command to the display unit to paste a file. One having ordinary skill in the art will appreciate that the gestures and events listed above are intended to be non-limiting examples of the possible gestures and events that can be defined in the gesture repository. The gesture repository can store up to 10 gestures, up to 25 gestures, up to 50 gestures, up to 100 gestures, up to 150 gestures, up to 200 gestures, up to 250 gesture definitions, and so forth, as well as associated event definitions.

One having ordinary skill in the art will appreciate that users can customize the gesture repository. Users can create new gestures, assign specific tasks to new or created gestures, delete gestures, or edit and/or switch the existing gesture definitions in the gesture repository. In the case of multiple display units in a system, each display unit can be customized to include a different set of gestures that is associated therewith. Alternatively, each display unit can associate a different event with each gesture, which can be interpreted by the systems 100, 200 to perform different tasks. For example, a “single tap” gesture on the display unit by a first user device can trigger a synchronization event that generates a command to synchronize the display unit 4 with the user device, while a “single tap” gesture on the display unit by a second user device can trigger a “delete” event that generates a command to delete a selected file from the display unit 4.

The display memory 46 can also store user authorization information. The display unit 4 can be configured such that users must be authorized in the system to be able to add, copy, paste, and generally modify digital content. User authorization can be linked to the wearable device, though it will be appreciated that user authorization can be based on a particular handheld device, an IP address, or other identifying information. The authorization information can be stored in the display memory and accessed following event detection.

For either a handheld user device 2, or a wearable user device 2, user authorization can occur when the user, wearing the user device 2, performs a gesture on, or relative to, the display unit 4. For example, event data from a motion gesture, e.g., a “double tap” gesture on the display unit, can be shared across system modules. The display unit 4 can access the display memory 46 to identify whether the source user device 2 is authorized such that the user device can perform content editing. The display memory 46 can identify the user device, and if the user device is authorized, can access the gesture repository to associate the gesture with an event according to user device settings. A user device is authorized if its credentials are registered within the modules of the system 100, 200, e.g., the display unit 4, the cloud infrastructure 10, and so forth. If the display memory 46 cannot recognize the user, the user is non-authorized. The system 100, 200 does not perform tasks in response to gestures performed using a non-authorized user device 2. Further, content push-pull can be disabled for non-authorized users and, in some embodiments, non-authorized users cannot make content modifications. Non-authorized users can browse content, though it will be appreciated that in some embodiments, the ability to browse can also be disabled for non-authorized users.

In some embodiments, the user device 2 can include a “lock” mode in which the user device 2 is disabled and cannot be used without authorization. A user device in the “lock” mode can have a blank display, prompt the user for a password or passcode, and/or disable device functionality in a manner familiar to one having ordinary skill in the art. An authorized user can “unlock” the user device in order to use the user device 2 to perform gestures within the system 100, 200. Authorization of the user device 2 can be completed by inputting user credentials into the user device 2. Some non-limiting examples of inputs can include a password, passcode, biometrics, e.g., a fingerprint, iris scanner, eye scanner, face scanner, voice recognition, and/or any other form of identification known to one having ordinary skill in the art.

The display memory 46 can store content that can record connectivity and event information transfer between modules. In some embodiments, the display memory 46 can store a history, or list, of previously connected user device(s). The list of previously connected user device(s) can be used to accelerate, or bypass, authorization of the user device 2 for devices that have previously been authorized. In some embodiments, the display memory 46 can include a cache (not shown) to improve connectivity and data transfer. The cache can store user settings from the user device 2, the display unit 4, the cloud infrastructure 10, and other system modules to allow for faster connectivity between modules when the user device accesses the system. The cache can also store settings that the display unit 4 uses to connect to other system modules to expedite data transfer therebetween. In some embodiments, the display memory 46 can also include an information transfer log (not shown) to track information transferred between modules, monitor users' access history, confirm synchronization of event information across modules, and so forth.

It will be appreciated that the features of the display memory 46 discussed above can also be included in each of the device memory 16 and the cloud memory 76.

The display memory 46 can be connected to the display processor 48 to send instructions and event data thereto. The display processor 48 can be configured to detect events and communicate event data via the display communicator 44 to other system modules. The display processor 48 can be a programmable general-purpose or special-purpose microprocessor and/or any one of a variety of proprietary or commercially available single or multi-processor systems. The display processor 48 can include a central processing unit (CPU, not shown) that includes processing circuitry configured to process display unit data and execute various instructions. It will be appreciated that the display processor 48 can continuously scan the display unit 4 for events to ensure prompt receipt and assignment of temporal event signatures to each event. In some embodiments, the display processor 48 can passively receive a signal from the display unit when a gesture is initiated. In some embodiments, the display processor 48 can include a command buffer 58 for receiving event data and/or commands from the cloud infrastructure 10. The command buffer 58 can initiate performance of tasks as instructed by the command. The command buffer 58 can process the command received from system modules, e.g., cloud infrastructure 10, and initiate the interaction based on the command instructions.

For example, after the user device 2 performs a gesture relative to the display unit 4, e.g., the display unit 4 detects a swipe, touch, tap, and so forth performed by the user device 2, the display processor 48 can determine whether the gesture is associated with an event. The display processor 48 can include various features for locating and transmitting data. In some embodiments, the display processor 48 can include an event detector 60 configured to determine whether a gesture can be associated with an event. The event detector 60 can compare signals received from one or more display sensors 52 with gesture definitions in the gesture repository to determine if the gesture is associated with an event. The event detector 60 can also parse the gesture for event data such as event type, location, and/or timestamp, among others.

If the gesture is not known in the gesture repository, the display processor 48 does not communicate the event data to the rest of the system. If the gesture is associated with an event in the gesture repository, the display processor 48 can send event data to the display communicator 44. In some embodiments, the display processor 48 can include a report regulator 62 for creating reports based on event data. The report regulator 62 can compile the event data into one or more reports that can be sent to other system modules. The reports can include the event data gathered by the event detector 60 such as event type, location, and timestamp, among others. The report regulator 32 can connect to the display communicator 44 to send data to other system modules.

The display processor 48 and display communicator 44 can be connected to the display power and audio LSI 50, such as a power supply and internal sound card that can be used in receiving (input) and forwarding (output) audio signals to and/or from system modules. The display power and audio LSI 50 can provide affirmative interaction feedback, e.g., a sound effect, alert, and/or notification, once an event is detected by the system 100, 200.

The display unit 4 can include one or more sensors thereon that can detect gestures of the user device 2. The sensors of the display unit 4, as shown in FIG. 4, can include display sensors 52 that can be connected to the event detector 60 of the display processor 48 to relay gesture information thereto. The display sensors 52 can be configured to analyze the relative position between the display unit and the user device to detect events. In some embodiments, the display sensors 52 can be configured to analyze whether the gesture made by the user device 2 is associated with an event. In an exemplary embodiment, the display sensors 52 can include a gyroscope 53, accelerometer 56, and magnetometer 57 to determine the occurrence of motion events and acquire event data. One having ordinary skill in the art will appreciate the manner in which the gyroscope 53, accelerometer 55, and magnetometer 57 function in combination in order to acquire temporal and spatial event data, though, in some embodiments, the display unit 4 can include one or two of these devices. A number of other display sensors 52 that can detect motion or spatial orientation can be used in conjunction with, or instead of, the gyroscope, accelerometer, and magnetometer, e.g., IR range sensors 61, GPS sensors 63, among others, as appreciated by those skilled in the art.

The display sensors 52 can include one or more optical sensors for detecting gestures. Optical sensors can be used in conjunction with, or in lieu of, motion sensors, as described above. For example, in some embodiments, the display unit 4 can include a camera 64 that is configured to detect gestures. The camera 64 can be positioned on the display unit or in proximity with the display unit. After detection, the gestures can be analyzed by the display processor 48 to determine if an event can be associated therewith. It will be appreciated that multiple cameras can be used by the display unit 4 to detect gestures. Use of multiple cameras can increase the accuracy of gesture detection. Multiple cameras can be synchronized to produce more accurate spatial orientation measurements. Additional examples of optical sensors that can be used with the system can include video recorders, proximity detectors, fiber optic sensors, and so forth.

The display sensors 52 can include an output or display panel 8 that can display information and/or perform tasks based on commands received from system modules. The display panel can extend throughout the entire length of the display unit 4, or through a portion thereof. After computation is performed, the display unit 4 can output the command to the display panel for presentation. The output 8 can be configured to be interactive, as described further below, though it will be appreciated that in some embodiments, information on the display panel can only be modified using a wearable and/or handheld device. The display output 8 can also be fully customized by adjusting colors, sizes of icons, location of files, and so forth. Individual customizations can be set individually for each user, or default parameters can be input for the display panel by a system administrator. In some embodiments, the output 8 can include a selector 68 for modifying presentation content thereon. The selector 68 can include settings for changing colors, drawing shapes, deleting and/or drawing content thereon, and so forth.

In some embodiments, the display sensors 52 can include an input 59 for detecting touch gestures. The input 59 can be located on the display panel or can be separate from the display panel. The input 59 can be a screen, a USB, or any other display known in the art. In the exemplary embodiment, the display unit 4 can include a touchscreen that can detect gestures made thereon. The touchscreen can extend throughout the entire display panel or through a portion thereof (similar to a laptop trackpad). The touchscreen can enable users to interact directly with the display unit 4 by modifying content directly on the display panel. After a gesture is performed, the touchscreen can detect a gesture type and share the information with the display processor 48 to determine whether the gesture is associated with an event. The touchscreen can also share the timestamp and the location of the gesture relative to the display unit 4 with the display processor 48. In some embodiments, the touchscreen can allow users to control a pointer that can travel along the display panel of the display unit 4 to select, drag, delete, cut, and modify files, documents, and/or pictures that are displayed on the display panel.

In some embodiments, the display unit 4 can be configured to perform computations on event data and output tasks to be performed therewith. For example, event data from system modules can be sent to the display processor 48 to perform computations. The display processor 48 can normalize event data received from the user device(s), display unit(s) and other system modules by extracting event type, timestamp, and/or location data from the event data. The display processor 48 can analyze the data to determine if it is synchronized between two or more modules, e.g., if the event data, such as event type and timestamp, communicated by the user device 2 is the same as the event data communicated by the display unit 4. It will be appreciated that a number of other characteristics can be used to assess synchronization of two or more modules.

In some embodiments, the display processor can include a synchronization detector (not shown). The synchronization detector can evaluate reports and/or events to determine if data collected from multiple sources has the same event data. For example, the synchronization detector can compare event data between a display unit 4 and a user device 2 to determine if the events are distinguishable. In some embodiments, the synchronization detector can normalize the data to determine if two or more events are distinguishable.

Lack of synchronization between the user device 2 and the display unit 4 can indicate system error or an attempt by a non-authorized user to modify content. In such a scenario, the display processor 48 can send a command to the display panel to filter the non-authorized user. Otherwise, if the event data is synchronized between the user device 2 and the display unit 4, the display processor 48 can send a command to the display panel that the authorized user has been identified.

In some embodiments, event data can be sent from the display unit 4 and the user device 2 to a cloud infrastructure 10 over the network 6. The network 6 can enable the systems 100, 200 to communicate with remote devices (e.g., other computer systems) over a network, and can be, for example, remote desktop connection interfaces, Ethernet adapters, Bluetooth and/or other local area network (LAN) adapters known to one skilled in the art.

As shown in FIG. 5, a block diagram of an example cloud infrastructure 10 that can be used with the system of FIG. 1B discussed above. The cloud infrastructure 10 can include cloud components 72 such as a cloud communicator 74, a cloud memory 76 and a cloud processor 78 connected to a cloud power LSI 80. It will be appreciated that the cloud infrastructure 10 can include components that perform computations and output event data that are similar to those of the display unit. For example, the user device 2 and the display unit 4 can share event data with the cloud communicator 74. The cloud communicator 74 can share the event data with the cloud processor 78 to perform computations.

The cloud processor 78 can be a programmable general-purpose or special-purpose microprocessor and/or any one of a variety of proprietary or commercially available single or multi-processor systems. The cloud processor 78 can include a central processing unit (CPU, not shown) that includes processing circuitry configured to process user device data and execute various instructions. The cloud processor 78 can normalize event data received from the user device(s), display unit(s) and other system modules by extracting event type, timestamp, and/or location data from the event data. The cloud processor 78 can analyze the data to determine if it is synchronized between two or more modules, e.g., if the event data, such as event type and timestamp, communicated by the user device 2 is the same as the event data communicated by the display unit 4. It will be appreciated that a number of other characteristics can be used to assess synchronization of two or more modules.

In some embodiments, the cloud processor 78 can include a report receiver 77 that can receive data transferred from the device communicator 14 and/or the display communicator 44 for normalization. In some embodiments, the cloud processor 78 can include a synchronization detector 79. The synchronization detector 79 can communicate with the report receiver to evaluate reports and/or events to determine if data collected from multiple sources has the same event data. For example, the synchronization detector 79 can compare event data between a display unit 4 and a user device 2 to determine if the events are distinguishable. In some embodiments, the synchronization detector 79 can normalize the data to determine if two or more events are distinguishable.

The cloud processor 78 can be connected to the cloud memory 76. The cloud memory 76 can provide temporary storage for code to be executed by the cloud processor 78 or for data acquired from one or more users, storage devices, and/or databases. The cloud memory 76 can be configured to store user-specific settings and information for performing tasks. Some non-limiting examples of user-specific settings can include user access privileges, storage space for copied or saved files, and so forth. The cloud memory 76 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

As shown, the cloud components 72 can be connected to the cloud power LSI 80, such as a power supply and internal sound card that can be used in receiving (input) and forwarding (output) audio signals to and/or from system modules. The cloud power LSI 80 can provide affirmative interaction feedback, e.g., a sound effect, alert, and/or notification, once an event is detected by the systems 100, 200.

Lack of synchronization between the user device 2 and the display unit 4 can indicate system error or an attempt by a non-authorized user to modify content. In such a scenario, the cloud processor 78 can send a command to the output 8 to filter the non-authorized user. Otherwise, if the event data is synchronized, the cloud processor 78 can send a command to the output 8 that the authorized user has been identified. In some embodiments, the cloud processor 78 can include an interaction regulator 81. The interaction regulator 81 can include a unit for processing data, e.g., CPU, that can decipher tasks based on event data. The interaction regulator 81 can communicate with the display memory 76 to access data contained therein. The interaction regulator 81 can determine the task associated with the event that can be shared with other cloud processor components, e.g., the report regulator. Other command instructions can include to load user-specific settings, and outputs tasks to be performed on the display unit 4.

The display unit 4 can perform one or more output tasks in response to the command. The output task that is performed can depend on the type of interaction that exists between the user device 2 and the display unit 4. In some embodiments, a user having a wearable user device 2 can tap on a display unit 4 to synchronize the user device 2 and display unit 4. A synchronized event signature can be assigned between the display unit and the user device that records the type of event, e.g., single tap, that was performed. The event signature can then be shared between the user device and the display unit, e.g., over the network, as discussed above, to record the type of event performed. In some embodiments, the systems 100, 200 can assign a temporal event signature to the event to record the timestamp at which the event occurred. In some embodiments, the systems 100, 200 can assign a spatial event signature to the event to record the location of the event on the shared display.

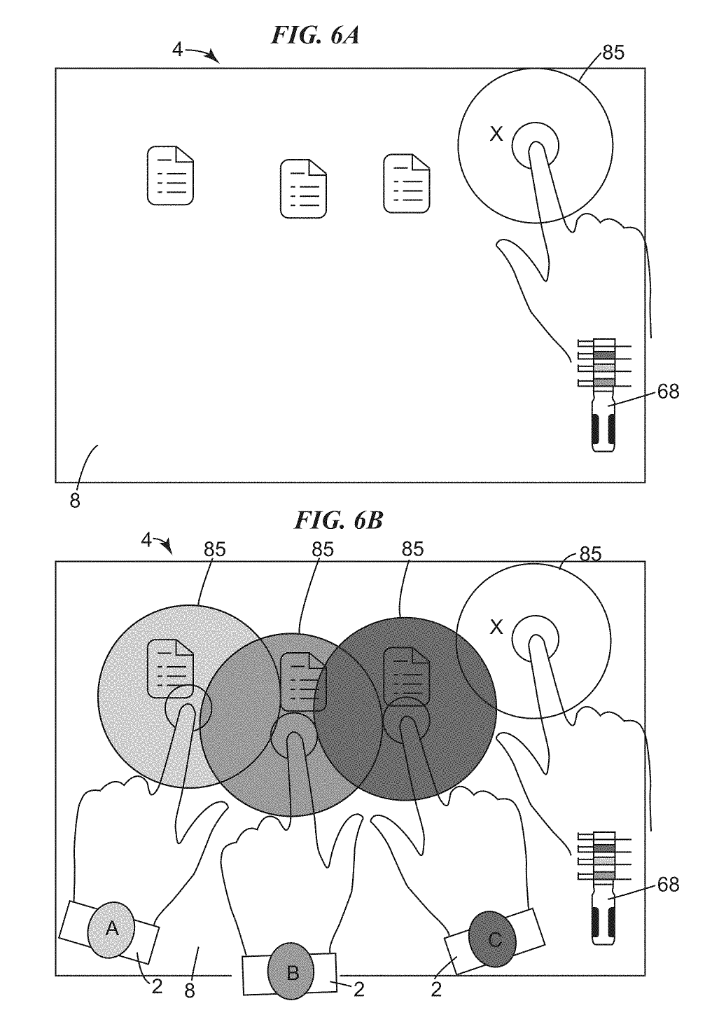

In some embodiments, the systems 100, 200 can determine that an event was created by a non-authorized user. In an exemplary embodiment, lack of synchronization between the user device 2 and the display unit 4 can suggest that the event was performed by a non-authorized user. It will be appreciated that events detected from gestures by non-authorized users can be the same, or similar to, events detected from gestures by authorized users, except non-authorized users are users that are not recognized by the systems 100, 200. Non-authorized users can include users who do not have a user device, as shown in FIG. 6A, users who have a user device that is on a different network from the display unit 4, and/or users who do not have proper permissions for accessing content on the display unit 4. In some embodiments, the display unit 4 can be configured to prevent all users from modifying all content such that every user is, in effect, a non-authorized user.

The display unit 4 can include a non-authorized mode of operation for non-authorized users. In the non-authorized mode, content modification, such as content push-pull, can be disabled. Users can interact with the display unit 4 but cannot perform actions such as copy, paste, and edit, though it will be appreciated that one or more of these functions can be active in the non-authorized mode. In some embodiments, the non-authorized mode can include a browse function to enable non-authorized users to search content that is stored or displayed on the display unit.

In some exemplary embodiments, the systems 100, 200 can allow personalized modification of content. Once the user device is identified, the user device can be used to modify content. The content can be user-specific content or public content. In some embodiments, the user can modify content until a time-out occurs. The time-out can be configured to be assigned by using a temporal filter to limit the time the user has to interact with the system 100, 200. For example, the user device 2 can perform a gesture, e.g., a “swiping” gesture, that the system can associate with an event used to identify the user device 2 in relation to the display unit 4. Once the user device 2 is identified, modifications of content can be enabled until the time allotted for modification runs out. It will be appreciated that the time-out duration from the time of identification can be set to occur in 5 seconds or more, in 10 seconds or more, in 15 seconds or more, in 20 seconds or more, in 30 seconds or more, in 40 seconds or more, and so forth. In some embodiments, the system does not contain a time-out and modification can thus occur for an indefinite amount of time. After time-out occurs, the user can be re-identified, e.g., by performing another “swiping” gesture, to continue to modify content.

In some embodiments, the time-out can be configured to be assigned by using a spatial filter to limit the space within which the user can modify content. For example, the time-out can occur after the user attempts to modify content outside of the limits set by a user area, as discussed further below.

Display unit and user device content can include metadata (not shown) associated therewith. Content modifications that are performed by users can add metadata that is specific to each user to the content so as to associate changes with a specific user. For example, following content modifications such as copying, pasting, deleting, and/or uploading of files, a metadata tag can be added to the file to record the event and/or the source of the event. Metadata tags can also be added to the display unit and/or the user device to record the modification. Users can access the history of the file, the user device 2, or the display unit 4 to review previous file versions or catalog previous events. This can allow previous versions of content to be accessed and to create a file history that can track the sources of content modifications, which can be a great source in the collection of user marketing data. In some embodiments, content modifications can be saved as a new version such that a history of complete documents can be created. In such embodiments, the edits performed by the user device 2 can be undone to return the file to a previous, unedited version.

In some embodiments, the display unit 4 can define a user area 85 for each user in response to a gesture. Once the display unit 4 detects that the gesture can be associated with an event, the display unit 4 can define the user area 85 around the event location. As shown in the illustrated embodiment of FIGS. 6A and 6B, the user area 85 can be portrayed as concentric circles centered around the event performed by the user device 2. The user area 85 can be centered around the user's point of contact with the display unit 4, as shown with regards to sample users A, B, and C, though it will be appreciated that the user area 85 can be centered around a file, a graphic, and the like. The location of the user area 85 can be calculated using the Cartesian coordinates (x- and y-coordinates) of the gesture relative to the display unit. In the illustrated embodiment, the systems 100, 200 can determine the x- and y-coordinates of the user's touching action and define the user area as a circle of a predetermined diameter in accordance with the user's personalized settings.

At a given temporal instance, the display unit 4 can include one or more user areas 85 defined thereon. Each user area 85 can overlap another user area 85, though configurations of the display unit 4 in which the user areas do not intersect are possible. As such, the systems 100, 200 can give users access to different content on the same screen. In the illustrated embodiment, the content displayed for each user in their respective user area 85 can be based on each user's access privileges, though it will be appreciated that access to content can depend upon user-specific settings, the area of the display unit with which the user interacts, and so forth. As shown in FIG. 6A, the non-authorized user does not have access to content in the user area 85. As shown in FIG. 6B, the authorized users can have access to a document within their respective user areas 85, which can be located on the same screen as the user area 85 of the non-authorized user. In some embodiments, the display unit 4 can reveal and/or hide content specific to each user. The option to reveal and/or hide can be set by the user-specific settings or by the user's access privileges to the systems 100, 200. In some embodiments, gestures can be associated with events that enable the user to select content to be revealed and/or hidden. In such embodiments, the user can perform the gesture on the display unit 4, e.g., “triple tap” the icon of a file to hide and/or “triple tap” an area of the display unit to reveal files hidden within the user area, to interact with the content.

Users can be prevented from modifying content that is located in a user area 85 that belongs to another user, though settings can be customized such that modification of another user's content is possible. It will be appreciated that the size and shape of each user area 85 can vary as desired. The size and shape can vary based on display size, type of event, size of the file, and/or user-specific settings that are set by the user or by the system. Each user area 85 can have the same size, shape, and/or color as another user area, though these parameters can differ across display units or in a single display unit. The size, shape, and/or color can also be changed based on user device or display unit preferences, or the identity of users that interact with the display unit such that two or more users do not have the same user area. In some embodiments, two or more users can have the same user area. In some embodiments, two or more users can share a single user area.

Authorized users can trigger various functions based on event type. It will be appreciated that the functions described below represent some non-limiting examples of functions of the system 100, 200 and many additional functions are possible. In an exemplary embodiment, as shown in FIG. 6B, users having a wearable user device can interact with a touchscreen display unit using different gestures. As described above, the systems 100, 200 can provide different content for each user device based on the access privileges granted to the user device. Access privileges can be defined by the settings of the user device 2, the display unit 4, the cloud infrastructure 10, another system module, and/or a combination of these modules.

In some embodiments, authorized users can perform a gesture on the display unit 4 to trigger a “copy” event. The “copy” event can generate a command to make a copy of a document, file, and/or graphic. After the event is synchronized between the user device 2 and the display unit 4, the file can be downloaded onto the user device 2. The user device 2 can then perform a gesture on the display unit 4 to trigger a paste event that generates a command to save the file to specified locations. It will be appreciated that the file can be pasted in the same location on the display unit 4, in a different location on the display unit, in a different display unit, and/or in another system module. The file can be pasted in a single location, though, in some embodiments, the file can be pasted in multiple locations. In some embodiments, the file can continue to be saved to specific locations until another “copy” event is triggered on a second file. After a second “copy” event is triggered, the first file can be deleted from the user device 2, and the second file can be saved to specified locations. In some embodiments, a copied file can reside on the display unit 4 and/or on the cloud infrastructure 10. After a “paste” event is triggered, the synchronization between the user device 2, the display unit 4, and/or the cloud infrastructure 10 can save a copy of the file from the display unit 4 and/or the cloud infrastructure 10 to the specified location.

In some embodiments, authorized users can perform a gesture on the display unit 4 to trigger a “delete” event. The “delete” event can generate a command to delete a document, file, and/or graphic from one of the user device 2, display unit 4, and/or cloud infrastructure 10. After the event is synchronized between the user device 2 and the display unit 4, the file can be deleted from the user device 2, display unit 4, and/or cloud infrastructure 10. It will be appreciated that each of the user device 2, the display unit 4, and/or the cloud infrastructure 10 can include an archive (not shown) that can be configured to store deleted files.

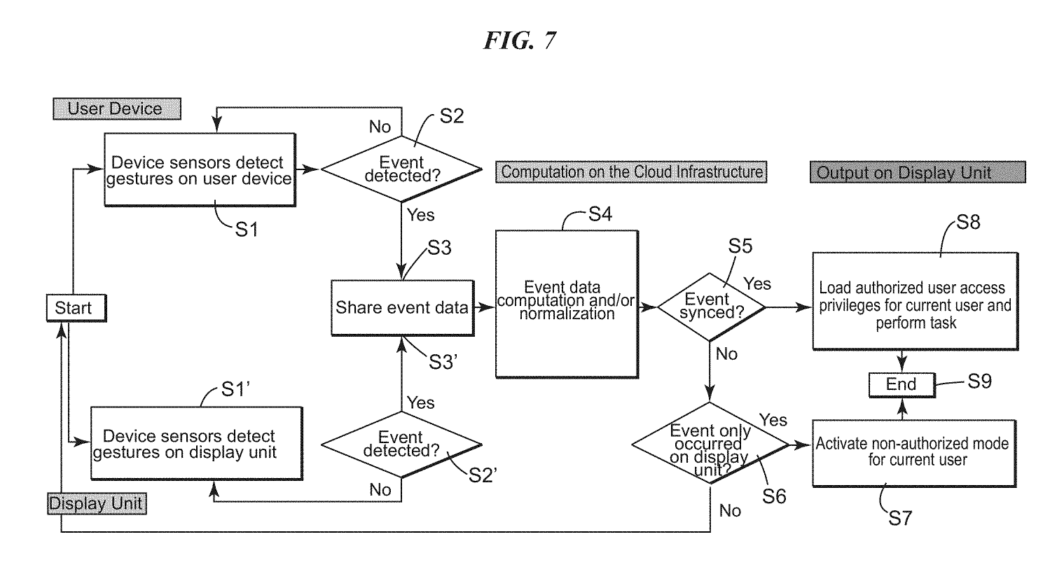

FIGS. 7-10 are simplified flow diagrams of processes that may be used by embodiments of the systems 100, 200 described herein. The systems 100, 200 can use temporal-spatial event detection to initiate interaction between the display unit 4 and the user device 2 to perform tasks such as saving a file to the user device 2, the display unit 4, and/or the cloud infrastructure 10. It will be appreciated that although the processes can begin with gestures being detected by either of the user device 2, the display unit 4, or the cloud infrastructure 10, only one of these scenarios is discussed herein for the sake of brevity. Further, the exemplary process described below will be discussed with regards to a “double tap” gesture at a time ti on a touchscreen of the display unit 4. The “double tap” gesture can trigger an event that can generate a command to save a file to the display unit 4. It will be appreciated that the processes described below can apply to a variety of gestures. In other embodiments, the “double tap” gesture trigger an event that can generate a different command, e.g., copy, paste, and/or delete a file.

In step S1, the device sensors 22 can detect the “double tap” gesture of the user device 2 on the display unit 4. After the gesture is detected, the process flow can proceed to step S2 where the device processor 18 can analyze the gesture to determine if it is associated with an event. The device processor 18 can include a direct connection to each of the sensors, or the device processor 18 can detect a signal transmitted from the device sensors via the device communicator 14. If there is no event detected, the device processor 18 does not share event data with system modules and the process flow returns to step S1 where device sensors 22 can await occurrence of the next event. If the device processor 18 detects an event, the process flow can proceed to step S3. In step S3, event data can be sent to the device communicator 14 to be shared with system modules.

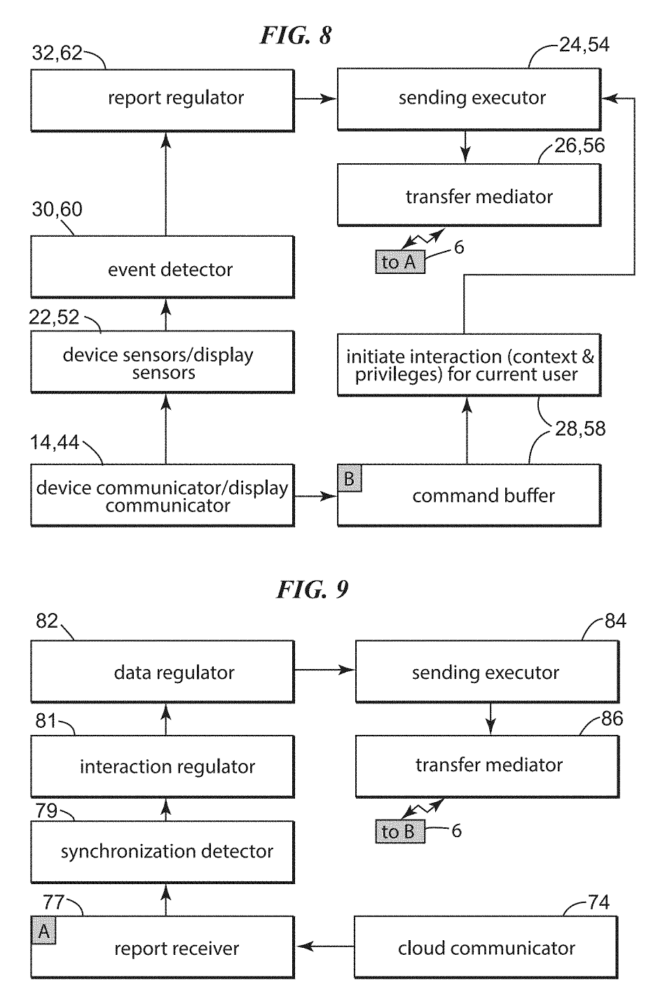

In some embodiments, as shown in FIG. 8, the event detector 30 can analyze gestures received by the device processor 18. The event detector 30 can be configured to analyze the gesture to detect events. To analyze the gesture, the event detector 30 can access the device memory 16 to determine if the gesture is associated with an event. In some embodiments, the event detector 30 can read the gesture repository to find the event that is most closely associated with the gesture. Event data such as the event type, location on the display unit, and/or timestamp of the event can be recorded. In an alternate embodiment, the event data can be used to create a metadata file to track the event data that corresponds to the event. After the event data is gathered, the event data can be sent to the report regulator 32 to generate a report that records the event data. After the report is generated, the report regulator 32 can send the report and/or the event data to the device communicator 14. The data can be sent by the sending executor 24 to the transfer mediator 26 for sending to other system modules.

In step S1′, the display sensors 52 can detect the “double tap” gesture on the display unit 4. After the gesture is detected, the process flow can proceed to step S2′ where the display processor 48 can analyze the gesture to determine if it is associated with an event. The display processor 48 can include a direct connection to each of the sensors, or the display processor 48 can detect a signal transmitted from the device sensors via the display communicator 14. If there is no event detected, the display processor 48 does not share event data with system modules and the process flow returns to step S1′ where display sensors 52 can await occurrence of the next event. If the display processor 48 detects an event, the process flow can proceed to step S3′. In step S3′, event data can be sent to the display communicator 44 to be shared with system modules.

In some embodiments, as shown in FIG. 7, the event detector 60 can analyze gestures received by the display processor 48. The event detector 60 of the display processor 48 can be configured to analyze the gesture to detect events. To analyze the gesture, the event detector 60 can access the display memory 46 to determine if the gesture is associated with an event. In some embodiments, the event detector 60 can read the gesture repository to find the event that is most closely associated with the gesture. Event data such as the event type, location on the display unit, and/or timestamp of the event can be recorded. In an alternate embodiment, the event data can be used to create a metadata file to track the event data that corresponds to the event. After the event data is gathered, the event data can be sent to the report regulator 62 to generate a report that records the event data. After the report is generated, the report regulator 62 can send the report and/or the event data to the display communicator 44. The data can be sent by the sending executor 54 to the transfer mediator 56 for sending to other system modules for computation and output.

FIG. 9 illustrates the processes performed by the cloud infrastructure 10 of FIG. 7 for performing a synchronization computation thereon. Event data from the display processor 48 and the device processor 14 sent by the transfer mediators 26, 56 can be received by the cloud infrastructure 10 in step S4 for comparison and normalization. As shown in FIG. 9, data from the transfer mediator 26, 56 can be received by the report receiver 77. After receipt of the event data, the report receiver 77 can send the report to the synchronization detector 79. The synchronization detector 79 can compare the timestamp of the “double tap” and the location of the “double tap” on the display unit 4 according to event data received from each of the user device 2 and display unit 4. Using these values, the synchronization detector 79, in step S5, can determine whether the user device 2 and the display unit 4 are synchronized, e.g., whether the user device and the display unit recorded the same values for the timestamp and location of the “double tap” event. Results of the synchronization can be sent to the interaction regulator 81 to generate the command to be sent to the display unit 4 and/or the user device 2.

In the exemplary embodiment, the interaction regulator 81 can access the gesture repository of the cloud memory 76 to determine parameters of the command. As mentioned above, the command can identify the user device 2, define user privileges, and/or acquire the task associated with the “double tap” event, e.g., save a file to the display unit 4. After the task is acquired, the interaction regulator 81 can send the command to save the file to the data regulator 82 to initiate sharing of the command between system modules, e.g., user device, display unit, and/or display panel. The data regulator 82 can send the command to the cloud communicator 74. A sending executor 84 of the cloud communicator 74 can send the command to the transfer mediator 86 for sending to the display unit 4 and/or user device 2 for synchronization and output.

Data sent by the transfer mediator 86 can be received by the command buffer 28, 58. The command buffer 28, 58 can initiate interaction between the user device 2 and the display unit 4 based on the content of the command. User privileges such as data transfer and content modification can be regulated based on outputs of the synchronization detector 79 and the data regulator, as discussed above. For example, if the event data is not synchronized between the user device 2 and the display unit 4 such that the “double tap” has a different timestamp and/or location on the display unit, the synchronization detector 79 communicates that the user device 2 and the display unit 4 are not synchronized. The process can then proceed to step S6 where the synchronization detector 79, or another component of the cloud processor 78, can evaluate whether the event only occurred on the display unit 4. If the event is determined to have occurred only on the display unit 4, or only on the user device 2, the file will not be saved because the event was performed by a non-authorized user. In response, the process can proceed to step S7 where the system 100, 200 can launch the non-authorized mode on the display unit 7. If, during step S7, the event is determined to not have occurred on either the user device 2 or the display unit 4, the process returns to steps S1 and S1′.

Alternatively, if event data is synchronized between the display unit 4 and the user device 2, the command buffer 28, 58 can prompt the display processor 48 and the device processor 18 to access the display memory 46 and the device memory 16, respectively. The process can advance from step S5 to step S8 where the processors can load user privileges and save the file based on the data stored in the gesture repository in each of the processors. For the user device 2 and display unit 4 of the exemplary embodiment, the gesture repository can associate a “double tap” with saving the file and can confirm that the user has appropriate privileges for doing so. In response, the display processor 48 and the device processor 18 can save a version of the file onto the user device 2. It will be appreciated that the file can be saved in the location of the user's point of contact with the display unit 4, e.g., the user area 85. In the exemplary embodiment, the location of the saved file can be determined by the x- and y-coordinates of the “double tap” gesture on the display unit 4.

After the command buffers 28, 58 initiate interaction between the user and the system, the display processor 48 and the device processor 18 can send an update of task performance, e.g., that the file was saved successfully, to the cloud infrastructure 10 to maintain synchronization across the system 100. In the illustrated embodiment, the command buffers 28, 58 can send a signal to the sending executors 24, 54 to send an update to the cloud infrastructure 10 via the transfer mediators 26, 56 that the file has been copied. The report receiver 77 can then update the information throughout the cloud infrastructure 10. Alternatively, the device processor 18 and the display processor 48 can proceed to step S9 to terminate the process. The display processor 48 and the device processor 18 can then await occurrence of the next event, e.g., an event that would trigger a “copy” command in the system 100.

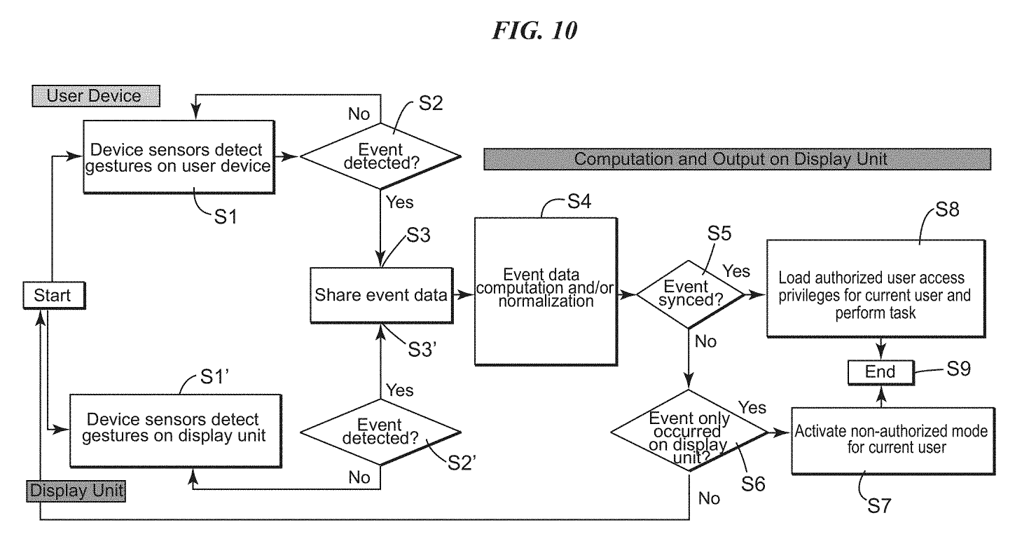

It will be appreciated that event data normalization and event synchronization determinations can be performed by system modules other than the cloud infrastructure. As shown in FIG. 10, computation of the event data gathered from the display unit 4 and the user device 2 can be performed by the display unit 4. The display unit 4 can determine if the event data is synchronized and can identify users and save the file as described above.

It will be appreciated that event data can be distinguished in real-time such that the user device 2 and the display unit 4 can simultaneously determine whether an event is detected. The user device 2 and the display unit 4 can be configured to synchronize in real-time in response to an event. For example, a “single tap” gesture on the display unit 4 can be associated with a synchronization event that generates a command to synchronize the user device 2 and the display unit 4. After the “single tap” gesture is performed, the user device and the display unit can both detect that an event was performed and share event data with one another. Once the event data is determined to be synchronized across the devices, the user device 2 can be synchronized to the display unit 4. To stop synchronization, a “single tap” gesture can be performed on the display unit 4. It will be appreciated that if the “single tap” gesture is performed on a surface that is not the display unit, or outside of the range of the display sensors 52 of the display unit 4, the user device 2 will not be synchronized with the display unit 4 because the event was not detected on the display unit 4. If during event data computations, event data shared by the user device 2 was not normalized due to the absence of event data from the display unit 4, no command is sent to the output and no tasks can be performed.

While the invention has been particularly shown and described with reference to specific illustrative embodiments, it should be understood that various changes in form and detail may be made without departing from the spirit and scope of the invention.

What is claimed is:

1. A method, comprising:
detecting occurrence of an event using a user device, the user device being configured to collect a first event data in a temporal instance;
detecting occurrence of the event using a display unit, the display unit being configured to collect a second event data in the temporal instance;
determining if the user device is authorized to perform a first task associated with the event by analyzing whether the first event data is synchronized with the second event data; and
performing the task that is associated with the event, if the user device is authorized.

2. The method of claim 1,
wherein the first event data is one or more parameters selected from the group consisting of an event type, a timestamp, a location of the event relative to the display unit, and a pattern received by one or more device sensors; and
wherein the second event data is one or more parameters selected from the group consisting of an event type, a timestamp, a location of the event relative to the display unit, and a pattern received by one or more display sensors.

3. The method of claim 2, wherein the parameters of the first event data are collected in the temporal instance.

4. The method of claim 2, wherein the parameters of the second event data are collected in the temporal instance.

5. The method of claim 1, wherein the event is detected using one of a motion sensor, an optical-visual sensor, an audio sensor, or a touch sensor.

6. The method of claim 1, wherein determining authorization of the user device is performed on a cloud infrastructure.

7. The method of claim 1, wherein determining authorization of the user device is performed on the display unit.

8. The method of claim 1,
wherein the user device further comprises a user memory that stores the task that is associated with the event; and
wherein the display unit further comprises a display memory that stores the task that is associated with the event.

9. The method of claim 1, further comprising performing a second task that is associated with the event, if the user device is authorized, the second task being different from the first task wherein a second user device comprises a second user memory that stores a second task that is associated with the event; and
wherein the display unit comprises a display memory that stores the second task that is associated with the event.

10. The method of claim 9, wherein the first task and the second task are performed within a same display output of the display unit.

11. The method of claim 1, wherein the first task further comprises annotating the display unit by modifying content thereon.

12. The method of claim 1, wherein the display unit further comprises a user area, the user area defining a space within which content can be modified.

13. The method of claim 12, wherein content in the user area cannot be modified by a second user device, the second user device being non-authorized to modify content in the user area.

14. The method of claim 11, further comprising adding a tag to the annotated content.

15. The method of claim 14, wherein the tag comprises user identification information and timestamp of modification.

16. The method of claim 1, wherein the event is a synchronization event that is configured to relay information from the user device to the display unit to perform the task.

17. A control system, comprising:
one or more user devices configured to perform one or more gestures, the user devices having a device processor that analyzes the gestures to gather a first event data therefrom;
a display unit configured to detect occurrence of one or more gestures relative thereto, the display unit having a display processor that analyzes the gestures to gather a second event data therefrom;
a network that connects the one or more user devices and the display unit, the network being configured to share the first event data and the second event data across the system; and
a computing module that receives the first event data and the second event data, the computing module being configured to perform computations to determine the existence of synchronization between the first event data and the second event data.

18. The system of claim 17, wherein the computations are performed by a cloud infrastructure connected to the network, the cloud infrastructure being configured to receive the first event data and the second event data therefrom.

19. The system of claim 17, wherein the computing module generates a command to perform a task if the first event data is synchronized with the second event data.

20. The system of claim 19, further comprising an output configured to perform the task and to receive the command to perform the task, the output being positioned on the display unit.
